(19) United States
(12) Patent Application Publication
(10) Pub. No.: US 2012/0288700 A1
(43) Pub. Date: Nov. 15, 2012

(54) COATING COMPOSITION

(76) Inventors: Robert McMullin, Cheshire, CT (US); Fred Lewchik, Newington, CT (US); Terry Lester, North Haven, CT (US)

(21) Appl. No.: 13/508,771

(22) PCT Filed: Nov. 10, 2010
(86) PCT No.: PCT/US10/56198

§ 371 Date: Jul. 31, 2012

Related U.S. Application Data
(60) Provisional application No. 61/260,239, filed on Nov. 11, 2009.

(51) Int. Cl. C09D 175/04; C09D 167/00; C09D 163/00; B05D 5/12; B05D 7/24; B32B 5/16; C08K 3/22; C08K 3/36; B82Y 30/00

(52) U.S. Cl. 428/220; 524/432; 524/430; 524/437; 524/413; 524/590; 524/601; 523/458; 523/457; 523/459; 523/466; 524/539; 524/502; 523/400; 523/456; 524/262; 427/58; 427/385.5; 428/328; 428/329; 428/331; 977/773

(57) ABSTRACT

A coating for a substrate is a cured coating composition which includes binder and particles, wherein the particles are inorganic, organic or organo-metallic; have diameters between about 1 and 500 nm; may be treated with a surface modifer; and wherein the cured coating composition is in direct or indirect contact with the substrate.

A cured coating composition provides corrosion inhibition or corrosion protection for a metallic substrate.

Crevice corrosion is a corrosion occurring in spaces to which the access of the working fluid from the environment is limited. These spaces are generally called crevices. Examples of crevices are gaps and contact areas between parts, under gaskets or seals, inside cracks and seams, spaces filled with deposits and under sludge piles.

Pitting corrosion, or pitting, is a form of extremely localized corrosion that leads to the creation of small holes in the metal. The driving power for pitting corrosion is the lack of oxygen around a small area. This area becomes anodic while the area with excess of oxygen becomes cathodic, leading to very localized galvanic corrosion. The corrosion penetrates the mass of the metal, with limited diffusion of ions, further pronouncing the localized lack of oxygen.

Intergranular corrosion (IGC), also termed intergranular attack (IGA), is a form of corrosion where the boundaries of crystallites of the material are more susceptible to corrosion than their insides. This situation can happen in otherwise corrosion-resistant alloys, when the grain boundaries are depleted of the corrosion-inhibiting compound by some mechanism.

High temperature corrosion is chemical deterioration of a material (typically a metal) under very high temperature conditions. This non-galvanic form of corrosion can occur when a metal is subject to a high temperature atmosphere containing oxygen, sulfur or other compounds capable of oxidising (or assisting the oxidation of) the material concerned. For example, materials used in aerospace, power generation and even in car engines have to resist sustained periods at high temperature in which they may be exposed to an atmosphere containing potentially highly corrosive products of combustion.

Seawater corrosion is a form of corrosion of metal exposed to seawater. Typically in such cases the metal is a structural component of a vessel (ship or boat) or a fixed structure either on the shore, offshore, or underwater. In these cases, seawater corrosion typically acts on a time scale of months to years. Corrosion is faster with higher salinity and to a lesser extent higher temperatures.

What is needed are corrosion resistant coatings for metallic substrates.

### DESCRIPTION

We have found that pre dispersed particles, or nanoparticles (having an average particle size of less than about 500 nm), can increase corrosion resistance (as measured by the Salt Spray test) of solvent-based coatings, water-based coatings, solvent-free coatings, radiation curable coatings and powder coatings for substrates (such as metal substrates) comprising resins. In certain embodiments, these nanoparticles may have an average size of 5 nm to 80 nm. Examples of such nanoparticles include but are not limited to Al₂O₃, Al(O)OH, CeO₂, SiO₂, TiO₂, and ZnO and ZrO₂.

A coating for a substrate is provided comprising a cured coating composition which comprises: i) 5 to 99 weight % binder (A) and ii) 0.01 to 75 weight % particles (B); wherein the particles (B) comprise inorganic, organic or organo-metallic particles, optionally comprising at least one alloy, metal, metal and/or semi-metal oxide, oxide hydroxide and/or hydroxide, or mixtures or combinations of different alloys, metals, metal and/or semi-metal oxides, oxide hydroxides and/or hydroxides, or inorganic salts, or typical corrosion inhibitors or combinations thereof; the particles (B) have diameters between 1 and 500 nm; the surface of the particles (B) is optionally treated with at least one surface modifying group; wherein the substrate is optionally metallic; and wherein the cured coating composition is adapted to be in direct or indirect contact with the substrate.

In particular embodiments, the cured coating composition comprises i) 10 to 95 weight %, optionally 20 to 90 weight %, binder (A) and ii) 0.1 to 60 weight %, optionally 0.5 to 40 weight %, particles (B). In other embodiments, the cured coating composition comprises about 2 weight % to about 10 weight % particles (B). In certain embodiments, the nanoparticle content may be between 0.2 weight % solid nanoparticle content and 4.5 weight % solid nanoparticle content based on the solids content of the resin.

In certain embodiments, the diameter of the particles (B) is below 200, optionally below 100 and further optionally below 60 nm. In certain embodiments the diameter of the particles (B) is greater than 5 nm, optionally greater than 10 nm and further optionally greater than 20 nm.

In certain embodiments, the surface of the particles (B) are modified by: (1) Polydilakylsiloxanes; (2) polar polydialkylsiloxanes; (3) polymeric modifiers; (4) organosilanes; (5) wetting and/or dispersing additives; (6) mixtures of one or more of the aforementioned substances (1) through (5). In some embodiments, the coating may contain a surface active agent (C) which is not a modifier of the particles (B).

In certain embodiments, the surface of the particles (B) are modified by the surface modifying group attaching to the surface of the particles via at least one chemical or non chemical bond, optionally a covalent, non covalent, or physical bond; the modifying group optionally comprising a spacer component which is unable to undergo reactions with the particle surface and is inert towards the coating. The bond may be a covalent bond, or a physisorptive interaction, chemisorptive interaction, electrostatic interaction, acid-base interaction, van der Waals interaction, or hydrogen bonding.

In certain embodiments, the cured coating composition has a modulus of elasticity that is decreased by 10%, optionally by 20%, and further optionally by more than 20%, in comparison to coating material not containing the components as claimed herein. In some embodiments, the cured coating composition is transparent.

The subject coating may be used for increasing the corrosion resistance of a substrate, optionally metallic substrate, on which the coating is applied directly or indirectly. According to certain embodiments, there is embedded between the cured coating composition and the substrate, one or more further coating layers which optionally contain pigments and/or fillers. According to certain embodiments, the cured coating composition is directly bound to the metallic substrate or alternatively a cathodic protection coating of 5 to 30 μm in depth is directly embedded between the metallic substrate and the cured coating composition.

In some embodiments, the cured coating composition has a depth of between 15 and 900 μm, in other embodiments between 15 and 30 μm.

The coating binder (A) may comprise a crosslinkable or non-crosslinkable resin, optionally at least one of the classes of acrylics, aminoplasts, urethanes, carbamates, carbonates, polyesters, epoxies, silicones or polyamides, and further optionally wherein the resin comprises functional groups characteristic of more than one said class. Optionally the binder may comprise at least one of one component polyurethanes, two component polyurethanes, acrylics, oil modified urethanes, long oil alkyds, polyurethane dispersions, acrylic emulsions, epoxies, or water reducible alkyds.

Metals substrates that may be coated to inhibit or resist corrosion include but are not limited to those metals, metal mixtures, metal composites or alloys, that may experience any mean of corrosion, such as oxidation, pitting corrosion, rusting, crevice corrosion, and the like. Illustrative but not limiting examples are iron, steel, aluminium, dye-cast-aluminum, dye-cast-alloys, magnesium-aluminum-alloys and the like. Substrates may also be plastic or glass.

Suitable particles (B) such as nanoparticles may be inorganic, organic or organo-metallic. Their physical nature can be crystalline, semi-crystalline or amorphous. Examples of suitable nanoparticles may consist of or may comprise at least one metal and/or semi-metal oxide, oxide hydroxide and/or hydroxide; or mixtures or combination of different metal and/or semi-metal oxides, oxide hydroxides and/or hydroxides. For example, nanoparticles may be comprised of mixed metal and/or semi-metal oxides, oxide hydroxides or hydroxides. Illustrative examples of suitable nanoparticles include but are not limited to ZnO, CeO₂, Al₂O₃, SiO₂, Al(O)OH, TiO₂, and ZrO₂.

Suitable nanoparticles may also consist of or may comprise other inorganic materials, including but not limited to inorganic salts such as phosphates, molybdates, tungstates, vanadates, sulfates, carbonates, cyanamides, hydroxyphosphites, phosphomolybdates, borates, borophosphates, and the like. Optionally such nanoparticles may be functionalised or doped.

Suitable nanoparticles may also consist of or may comprise typical corrosion inhibitors known from literature and/or which are commercially available. Examples of such corrosion inhibitors are disclosed in “Corrosion inhibitors: an industrial guide” by Ernest W. Flick, 2^{nd} edition, Noyes Publications, Park Ridge, N.J., USA 1993 (ISBN 0-8155-1330-5) and Bodo Mueller et al., “Coatings formulation: and international textbook Coatings Compendien”, Vincentz Network GmbH & Co KG, 2006 (ISBN 3878701772) which are incorporated herein by reference.

Examples of commercial corrosion inhibitors include but are not limited to BARIUM CHROMATE M20 (SNCZ Société Nouvelle des Couleurs Zinciques), HEUCOPHOS® CAPP (Heubach GmbH, calcium aluminum polyphosphate silicate hydrate), HEUCOPHOS® SAPP (Heubach GmbH, strontium aluminum polyphosphate hydrate), HEUCOPHOS® SRPP (Heubach GmbH, controlled adjusted modified strontium aluminum polyphosphate hydrate), HEUCOPHOS® ZAM-PLUS (Heubach GmbH, organic modified zinc aluminum molybdenum orthophosphate hydrate), HEUCOPHOS® ZAPP (Heubach GmbH, zinc aluminum polyphosphate hydrate with improved electrochemical activity), HEUCOPHOS® ZCP-PLUS (Heubach GmbH, zinc calcium strontium aluminum orthophosphate silicate hydrate), HEUCOPHOS® ZMP (Heubach GmbH, basic zinc molybdenum orthophosphate hydrate), HEUCOPHOS® ZPA (Heubach GmbH, zinc aluminum orthophosphate hydrate), HEUCOPHOS® ZPO (Heubach GmbH, organic modified basic zinc orthophosphate hydrate), HEUCORIN® FR (Heubach GmbH, zinc salt of phthalic acid), HEUCOSIL CTF (Heubach GmbH, pigment based on a calcium modified silica gel), NOVINOX® ACE 20 (SNCZ Société Nouvelle des Couleurs Zinciques, modified Zinc Phosphate), NOVINOX® PAM (SNCZ Société Nouvelle des Couleurs Zinciques, magnesium and aluminium polyphosphate hydrate), NOVINOX® PAS (SNCZ Société Nouvelle des Couleurs Zinciques, strontium and aluminium polyphosphate hydrate), NOVINOX® PAT15 (SNCZ Société Nouvelle des Couleurs Zinciques, alkaline earth phosphate), NOVINOX® PAT30 (SNCZ Société Nouvelle des Couleurs Zinciques, alkaline earth phosphate), NOVINOX® PAZ (SNCZ Société Nouvelle des Couleurs Zinciques, zinc aluminium polyphosphate hydrate), NOVINOX® PPS10 (SNCZ Société Nouvelle des Couleurs Zinciques, Zinc Calcium Strontium Phosphosilicate), NOVINOX® PZ02 (SNCZ Société Nouvelle des Couleurs Zinciques, organically modified basic zinc orthophosphate), NOVINOX® XCA02 (SNCZ Société Nouvelle des Couleurs Zinciques, Silica based anticorrosive pigment), NUBIROX 102 (Nubiola Inorganic Pigments, Organophilized Zinc Phosphate-Molibdate), NUBIROX 106 (Nubiola Inorganic Pigments, organophilized Zinc Phosphate-Molibdate), NUBIROX 213 (Nubiola Inorganic Pigments, Multiphase pigment based on Iron and Zinc Phosphates hydrate), NUBIROX 215 (Nubiola Inorganic Pigments, Multiphase pigment based on basic Iron and Zinc Phosphates hydrate), NUBIROX 301 (Nubiola Inorganic Pigments, Zinc free anticorrosive pigment), NUBIROX 302 (Nubiola Inorganic Pigments, Zinc Free Anticorrosive Pigment), NUBIROX N2 (Nubiola Inorganic

Pigments, Zinc Phosphate), NUBIROX SP (Nubiola Inorganic Pigments, Zinc Phosphate), PHOSPHINAL PZ04 (SNCZ Société Nouvelle des Couleurs Zinciques, hydrated zinc and aluminium orthophosphate), PHOSPHINOX PZ06 (SNCZ Société Nouvelle des Couleurs Zinciques, basic zinc orthophosphate tetrahydrate), STRONTIUM CHROMATE L203E (SNCZ Société Nouvelle des Couleurs Zinciques, low-dust yellow finely micronised powder), ZINC CHROMATE CZ20 (SNCZ Société Nouvelle des Couleurs Zinciques, zinc and potassium chromate), ZINC PHOSPHATE PZ20 (SNCZ Société Nouvelle des Couleurs Zinciques, zinc oxide free zinc orthophosphate tetrahydrate), ZINC PHOSPHATE PZW2 (SNCZ Société Nouvelle des Couleurs Zinciques, zinc phosphate), and ZINC TETRAOXYCHROMATE TC20 (SNCZ Société Nouvelle des Couleurs Zinciques, zinc tetraoxychromate).

Such commercially available corrosion inhibitors might be used directly or may be modified by typical means to comply with the properties of the present nanoparticles. Modifications may include but need not be limited to precipitation, re-crystallization, grinding, hydratisation, drying, dehydratisation or calcination.

Other corrosion inhibitors are hexamine, phenylenediamine, dimethylethanolamine, sodium nitrite, cinnamaldehyde, condensation products of aldehydes and amines (imines), hydrazine, ascorbic acid, compounds derived from tannic acid, salts of dinonylnaphthalene sulfonic acid and conductive polymers like polyaniline or polythiophene.

Examples of anodic inhibitors are chromate, nitrite, and pertechnetate. An example of a cathodic inhibitor may be zinc oxide.

Optionally, more than one of the aforementioned nanoparticles and corrosion inhibitors may be used in combination in a monomodal, bimodal or multimodal particle size distribution.

In another embodiment, such particles and corrosion inhibitors may be used in the form of primary particles, agglomerates, aggregates or core-shell particles. They may consist of or comprise organic and inorganic parts. Particles as described in DE102008021005A1 and DE102008021006A1 are also suitable for the disclosed purposes.

The type of corrosion protection provided by the nanoparticles and/or corrosion inhibitors can be physical protection, chemical protection, electrochemical protection, mechanical protection, anodic protection, cathodic protection, increased hydrophobicity, surface polarity, improved adhesion and/or forming barrier layers.

The nature of such particles might lead to an enrichment of particles in the coating, located at the surface or at the interface to the substrate in the coating, as described in EP1204701B1, incorporated herein by reference.

However, in certain embodiments, the particles or nanoparticles employed may be modified or unmodified alloys, metals, metal and/or semi-metal oxides such as ZnO, CeO₂, Al₂O₃, Al(O)OH, SiO₂, TiO₂, oxide hydroxides, hydroxides, phosphates, molybdates, tungstates, vanadates, silicates, chromates, nitrites and sulfates.

The production process of the particles employed, in particular of the inorganic particles, in particular nanoparticles, can be carried out by various processes such as, for example, ion exchange processes, plasma processes, sol/gel processes, precipitation, crystallization, comminution (e.g by milling) or flame hydrolysis, and the like. It is irrelevant by which process the particles are produced. Any particles or nanoparticles of the aforementioned types may be surface-modified. Further, the particles or nanoparticles may be used in powdered form or as dispersions.

The nanoparticles are particles with an average size between about 1 nm to about 500 nm. In certain embodiments the nanoparticles may have an average particle size greater than 5 nm; in other embodiments, the nanoparticles may have an average particle size greater than about 10 nm; and in still other embodiments the nanoparticles may have an average particle size greater than about 20 nm. Also, in certain embodiments the nanoparticles may have an average particle size less than about 200 nm and the coating containing them may be substantially transparent; in other embodiments the nanoparticles may have an average particle size less than about 100 nm and the coating containing them may be transparent; and in still other embodiments the nanoparticles may have an average particle size less than about 60 nm and the coating containing them may be highly transparent.

The determination of the particle size of inorganic particles or nanoparticles may be carried out by transmission electron microscopy (TEM). The nanoparticle dispersions to be tested are usually diluted, transferred to a carbon griddle (such as a 600 mesh carbon film) and dried; the analysis may be then carried out in each case with, for example, a LEO 912 transmission electron microscope. The evaluation of the TEM images may be carried out, for example, digitally with software of the company analySIS Soft Imaging System GmbH. The particle diameters are generally calculated in each case for at least 1000 particles in which the measured area of the particles or nanoparticles are correlated with a circle of identical area. Finally the mean value is derived from the results.

The particle size distribution of organic particles may be measured, for example, by an AF4 analysis system from Postnova. This method combines the separation of different particle sizes with particle size analysis by light diffraction. Asymmetric Flow Field-flow Fractionation (AF4) coupled with Static and Dynamic Laser Light Scattering (SLS/DLS) may be used to characterize the size of organic nanoparticles. Separations may be performed using a PostNova AF4-10.000 System, a PN3000SLS/DLS Light Scattering Detector and a PN3240 variable wavelength, 4-channel UV/Vis detector. Starting from the raw data, the size distribution of the samples may be determined by using PostNova's “3-column-strategy”. This is comprised of three independent methods to calculate the particle size of the latex samples. The first method uses calculations based on the FFF theory, developed by Prof. Giddings who is the inventor of FFF. To process the data a software package—NovaFFF Analysis—is used. The second method is based on size determination using nanoparticle standards and a calibration curve. The third method is using directly the DLS raw data to calculate the particle size distribution and is independent from separation times.

The subject particles or nanoparticles may be surface treated. Such surface treatments may be based on the following:

(1) polydialkylsiloxanes;

(2) polar polydialkylsiloxanes;

(3) polymeric modifiers;

(4) organosilanes;

(5) wetting and/or dispersing additives;

(6) mixtures of one or more of the aforementioned substances.

The preparation of the particles or nanoparticles may be carried out simply by mixing the modifier with a particulate, in particular a nanoparticulate, powder or with a nanoparticulate dispersion in liquid media, such that a chemical or non-chemical, such as a covalent, non-covalent or physical bonding of the modifier to the surface of the nanoparticles takes place. The conditions for this are guided by the reactivity of the functional groups to be reacted with one another and can be determined easily by the skilled person. In some embodiments, if a reaction does not already take place at room temperature, a chemical or non chemical, in particular a covalent or non-covalent or physical bond of the modifier may be achieved by heating the mixture of nanoparticulate powder or nanoparticulate dispersion and modifier at a temperature of about 80° C. for a period of about one hour.

### (1) Polydialkylsiloxanes

The surface of the subject nanoparticles may be at least partially covered with at least one kind of modifying group. The structure of the modifying groups is illustrated below:

The modifying group may be attached covalently to the particle surface. The modifying group may possess 1-10 structural elements which with the particle surface is able to build at least one covalent bond in each case. In addition the modifying group may be composed of a spacer component which is unable to enter into reactions with the particle surface and is also inert towards the matrix (other coatings constituents, plastics constituents, etc.). The spacer component of the modifying group may be formed from a polymer having a number-average molecular weight in the range from 300 to 5000 daltons. The structure of the spacer radical in some embodiments may be linear.

The modifier may be constructed from at least one, or two or more, anchor groups, which are reactive towards the particle surface, and also of a polydialkylsiloxane. The anchor groups with the linking structures may be mounted on the ends of the polydialkylsiloxane and may also be present as a side group on the polydialkylsiloxane. The following depiction illustrates the possible structures of the modifier:

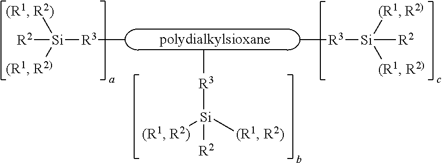

The definition of the indices is as follows:
a=0−1;
b=0−1;
c=0−10;
a+b+c≧1.

The structure of the modifier of one embodiment can also be described by way of the above schematic formula. In this case the indices have the following values: a=1 and b=c=0. This structure of modifier possesses the good activity in application. In this case the nanoparticles are characterized in that the modifier is a polysiloxane of the general empirical formula

R¹ₓR²₃₋ₓSi—R³—R⁴

in which R⁴ is a monovalent organic radical comprised of a polydialkylsiloxane having a number-average molecular weight of 300-5000 daltons, the alkyl substituents on the silicon atom having 1-8 carbon atoms. This can be illustrated as follows:

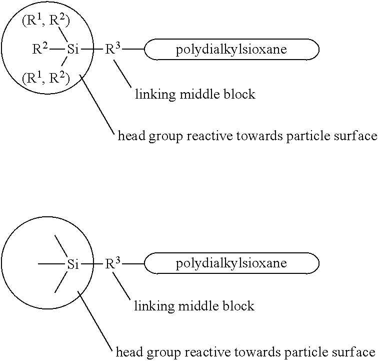

In other words, the modifier is comprised of a head group, which is reactive towards the particle surface, of a linking middle block (R³) and of a polydialkylsiloxane (R⁴) end group. The linear molecular structure of the modifier is particularly advantageous, although branched structures may also be used. R¹ may comprise a monovalent organic radical having 1-18 carbon atoms, optionally 1-3 carbon atoms. R² may comprise an OH group or hydrolysable group consisting of: linear or branched or cyclic alkoxy group having 1-6 carbon atoms, optionally having 1-2 carbon atoms; a halogen atom, optionally a chlorine atom, or, a carboxylic acid radical having 1-4 carbon atoms, optionally 2 carbon atoms.

In the case of this embodiment also the modifying group may be attached to the particle surface via at least one, in certain embodiments two and more, and in some embodiments via three covalent bonds. The modifying group also may be composed of a spacer component which is unable to undergo reactions with the particle surface and is likewise inert towards the matrix (other coatings constituents, etc.). The spacer component of the modifying group may be formed from a polymer having a number-average molecular weight in the range from 300 to 5000 daltons. The structure of the spacer radical may be linear.

Suitable polydialkylsiloxanes are disclosed in US 2006/0204528 A1, incorporated herein by reference.

### (2) Polar Modified Polydialkylsilanes

The structure of the modifier may be illustrated schematically by way of an example as follows, whereby in the illustrated example three different polar substituents or modifying groups (G) have been selected for the radical R⁴ (=polydialkylsiloxane) in the diagram:

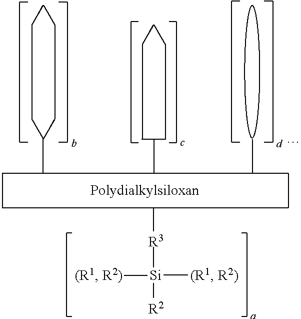

The index a describes the number of anchor groups, and the indices b, c, d . . . describe the number of preferably polar substituents or modifying groups (G) in the side groups of the polydialkylsiloxane (R⁴), whereby:

a≧1 and b+c+d+. . . ≧1

A surface modification of the particles can be carried out with silanes, which in general are bound to the particle surface through at least one chemical, in particular covalent, bond and advantageously may have one or more spacer components.

The preparation of the modifier is familiar to the skilled person and can be achieved for example as follows:

Starting from commercially available open-chain and cyclic polydimethylsiloxanes and Si—H-functional polydimethylsiloxanes, Si—H-functional polydimethylsiloxanes may be prepared in an equilibration reaction (as described in, e.g. Noll, “Chemie and Technologie der Silicone” [Chemistry and Technology of Silicone], Wiley/VCH Weinheim 1984), which can be converted into the modifier reagent employed in further steps. The number of Si—H groups in the Si—H-functional polydimethylsiloxane may be at least two, providing at least one Si—H group for attachment of the anchor group (R¹ₓR²₃₋ₓSiR³)_{y} and at least one Si—H group for attachment of the polar modification.

Unsaturated compounds such as, for example, 1-octene, 1-decene, 1-dodecene, 1-hexadecene and 1-octadecene, may be attached to polysiloxanes having Si—H groups by known methods using suitable catalysts such as, for example, hexachloroplatinic acid, Speyer's catalyst, platinum divinyltetramethyldisiloxane complex or in the presence of platinum compounds attached to supports; the hydrosilylation conditions are generally known, the hydrosilylation temperature lies between room temperature and 200° C., and in some embodiments between 50 and 150° C., depending on the catalyst employed.

In analogy to the attachment of alkenes other compounds with unsaturated groups may alternatively be added to Si—H groups within the sense of a hydrosilylation. For example, polyalkyleneglycol allylalkyl ether (e.g. polyglycol AM types, Clariant GmbH) or trialkoxyvinylsilane (e.g. Dynasylan VTMO or Dynasylan VTEO, Degussa AG) may be added to Si—H groups.

Also addition compounds of lactones such as, for example, ε-caprolactone and/or δ-valerolactone, to ethylenic unsaturated alcohols such as, for example, allyl alcohol, hexenol, allyl glycol or vinylhydroxybutyl ether, may be added to Si—H groups. For example, these compounds may be alkylated or acylated.

In addition to the possibility of the addition of ethylenic unsaturated compounds to Si—H groups one may also couple hydroxyl-functional compounds to Si—H functional polydimethylsiloxanes in a condensation reaction. For example, polyalkyleneglycol monoalkyl ethers (e.g. butylpolyethyleneglycol) may be condensed with Si—H groups with cleavage of hydrogen gas in this known process. For example, zinc acetylacetonate may be employed as catalyst in this reaction. In an analogous manner other substituents can also be inserted into the polydimethylsiloxane, for example groups having ester groups.

Hydrosilylation and condensation reactions may also be carried out to modify Si—H-functional polydimethylsiloxanes. It is also possible for a combined method to be used to prepare the modifier.

In contrast to hydrosilylation (formation of an Si—C bond) an Si—O linkage is formed in the condensation reaction.

In this way the radical R⁴ can be modified through the polar groups (G) as listed, for example, under (i) to (iv):
(i) group (G1) containing (poly)ether groups, in particular based on at least one alkylene oxide,
(ii) group (G2) containing polyester groups,
(iii) group (G3) containing arylalkyl groups,
(iv) group (G4) containing perfluorinated alkyl groups.

### (3) Polymeric Modifiers

Additionally other modifiers are copolymerisation products made from a one or more double bond containing organosilane which is additionally capable to react with water to form silanol groups, for example:
vinyltrimethoxysilane
vinyltriethoxysilane
vinyltriacetoxysilane
vinyltriisopropylsilane
vinyltris(2-methoxyethoxy)silane
methylvinyldimethoxysilane
vinyldimethylethoxysilane
allyltrimethoxysilane
allyltriethoxysilane
allyloxyundecyltrimethoxysilane
butenyltriethoxysilane
hexenyltrimethoxysilane
octenyltrimethoxysilane
3-(N-styrylmethyl-2-aminoethylamino)-propyltrimethoxysilane
styrylethyltrimethoxysilane
3-(meth)acryloxypropyltrimethoxysilane
3-(meth)acryloxypropyltriethoxysilane
3-(meth)acryloxymethyltrimethoxysilane
3-(meth)acryloxymethyltriethoxysilane
3-(meth)acryloxypropylmethyldiethoxysilane
3-(meth)acryloxypropylmethyldimethoxysilane
   with one or more of the following monomers:

Alkyl(meth)acrylates derived from linear or branched or cycloaliphatic alcohols with 1-22 C atoms, for example:
Methyl(meth)acrylate, Ethyl(meth)acrylate, n-Butyl(meth)acrylate, i-Butyl(meth)acrylate, t-Butyl(meth)acrylate, Lauryl(meth)acrylate, 2-Ethylhexyl(meth)acrylate, Stearyl(meth)acrylate, Tridecyl(meth)acrylate. Cyclohexyl(meth)acrylate, Isobornyl(meth)acrylate, Allyl(meth)acrylate and t-Butyl(meth)acrylate;

Aryl(meth)acrylates, for example:
Benzyl(meth)acrylate or Phenyl(meth)acrylate, including the unsubstituted and substituded arylic groups, for example 4-Nitrophenylmethacrylate;

Hydroxyalkyl(meth)acrylate derived from linear or branched or cycloaliphatic diols with 2-36 C atoms, for example:
3-Hydroxypropylmethacrylate, 3,4-Dihydroxybutylmonomethacrylate, 2-Hydroxyethyl(meth)acrylate, 4-Hydroxybutyl(meth)acrylate, 2-Hydroxypropylmethacrylate, 2,5-Dimethyl-1,6-hexandiolmonomethacrylate, and Hydroxyphenoxypropylmethacrylate;

Mono(meth)acrylate derived from oligomeric or polymeric ether, for example:
Polyethylenglycol, Polypropylenglycol or mixed Polyethylen/propylenglycol, Poly(ethylenglycol)methylether(meth)acrylate, Poly(propylenglycol)methylether(meth)-acrylate with 5-80 C atoms, Methoxyethoxyethyl(meth)acrylate, 1-Butoxypropyl(meth)acrylate, Cyclohexyloxymethyl(meth)acrylate, Methoxymethoxy-ethyl(meth)acrylate, Benzyloxymethyl(meth)acrylate, Furfuryl(meth)acrylate, 2-Butoxyethyl(meth)acrylate, 2-Ethoxyethyl(meth)acrylate, Allyloxymethyl(meth)acrylate, 1-Ethoxybutyl(meth)acrylate, 1-Ethoxyethyl(meth)acrylate, Ethoxymethyl(meth)acrylate, Caprolactone- and/ or Valerolactone-modified Hydroxyalkyl(meth)acrylate with a molecular weight between Mₙ=220−1200;

(Meth)acrylate derived from alcohols with halogen substitution, for example:
Perfluoroalkyl(meth)acrylate with 6-20 C atoms;

Oxirane-containing (Meth)acrylate, for example:
2,3-Epoxybutylmethacrylate, 3,4-Epoxybutylmethacrylate and Glycidyl(meth)acrylate;

Styrene and substituted Styrenes, for example:
a-Methylstyrol or 4-Methylstyrol;

Methacrylonitrile and Acrylonitrile;

Vinylgroup containing, non-alkaline heterocyclics, like for example
1[2-(Methacrylyloxy)-ethyl]-2-imidazolidin and N-Vinylpyrrolidon, N-Vinylcaprolactam; Vinylester derived from carboxylic acids with 1-20 C-atoms, for example:
   Vinylacetate; Maleic acid, maleic acid anhydride, Monoester and Diester of maleic acid; Maleinimide, N-Phenylmaleinimide and N-substituted Maleinimides with linear or branched or cycloaliphatic alkylgroups with 1-22 C atoms, for example:
      N-Ethylmaleinimide and N-Octylmaleinimide;

(Meth)acrylamide;

N-Alkyl- and N,N-Dialkylsubstituted Acrylamides with linear or branched or cycloaliphatic alkylgroups with 1-22 C atoms, for example:
N-(t-Butyl)acrylamide and N,N-Dimethylacrylamide;

Silylgroup containing (Meth)acrylates, for example:
(Meth)acrylic acid(trimethylsilylester) and Methacrylic acid-[3-(trimethylsilyl)-propylester];

(Meth)acrylic acid, Carboxyethyl(meth)acrylate, Itaconic acid, Fumaric acid, Maleic acid, Citraconic acid, Crotonic acid, cinnamic acid, Vinylsulfonic acid, 2-Methyl-2-[(1-oxo-2-propenyl)amino]-1-propansulfonic acid, Styrenesulfonic acid, Vinylbenzosulfonic acid,

Vinylphosphonic acid, Vinylphosphoric acid, 2-(Meth)acryloyloxyethylphosphate, 3 -(Meth)acryloyloxypropylphosphate, 4-(Meth)acryloyloxybutylphosphate, 4-(2-Methacryloyloxyethyl)trimellithic acid, 10-Methacryloyloxydecyldihydrogenphosphate, Ethyl-2- [4-(dihydroxyphosphoryl)-2-oxabutyl]acrylate, 2-[4-(Dihydroxyphosphoryl)-2-oxabutyl]acrylic acid, 2,4,6-Trimethylphenyl-2-[4-(dihydroxyphosphoryl)-2-oxabutyl]acrylate; and unsaturated fatty acids, acidic monomers mentioned in EP 1674067 A1;

N,N-Dimethylaminoethyl(meth)acrylate, N,N-Dimethylaminopropyl(meth)acrylate;

Aminogroup containing (C1-C6) alkyl(meth)acrylamide, for example:
N,N-Dimethylaminopropyl-(meth)acrylamide,

Vinylheterocyclics, for example:
4-Vinylpyridine, 2-Vinylpyridine, Vinylimidazole.

It is also possible to use acidic monomers with more than one carboxylic group in the form of the partially esterified compound.

### (4) Organosilanes

Particle surfaces may be treated with organosilanes which are capable of reacting with the particle surface and building at least one covalent bond to the particle surface, and which possess one or more spacer components.

By way of example there may be used alkyl-bearing functional silanes of the general empirical formula:

R⁷₍₄₋ₓ₎SiR⁶ₓ

in which the indices and variables have the following definitions:

x=1−3
R⁶=monovalent organic radical having 1-18 carbon atoms, optionally 1-6 carbon atoms, further optionally 1-3 carbon atoms, optionally containing hetero atoms
R⁷=hydroxyl group or hydrolyzable group consisting of:
   linear or branched or cyclic alkoxy group having 1-6 carbon atoms, in particular having 1-2 carbon atoms;
   a halogen atom, such as a chlorine atom, and
   a carboxylic acid radical having 1-4 carbon atoms, optionally 2 carbon atoms.

Additionally or alternatively there may be further modification of the particle surface with ether and/or ester groups. For this purpose silanes may be used of the following general empirical formula:

R⁸₍₄₋ₓ₎Si(R⁹—R¹⁰—R¹¹)ₓ

in which the indices and variables have the following definitions:

x=1−3
R⁸=hydroxyl group or hydrolyzable group comprised of:
   linear or branched or cyclic alkoxy group having 1-6 carbon atoms, in particular having 1-2 carbon atoms,
   a halogen atom, such as a chlorine atom, or
   a carboxylic acid radical having 1-4 carbon atoms, optionally 2 carbon atoms;
R⁹=oxygen or divalent organic group, e.g. alkylene radical or alkylene amine radical;
R¹⁰=divalent organic radical having a molar mass in the range 130-5000 daltons, comprising
   a polyether group optionally consisting of
      ethylene oxide
      propylene oxide
      butylene oxide
      mixtures of these oxides;
   an aliphatic and/or cycloaliphatic and/or aromatic polyester group containing at least three —C(═O)—O— and/or —O—C(═O)— groups,
R¹¹=-alkyl,
   acetoxy,
   —O—R¹², R¹² being an alkyl group having 1-18 carbon atoms, or
   —O—CO—NH—R¹³, R¹³ being an alkyl group having 1-18 carbon atoms.

For this purpose polyether or polyester containing hydrolyzable silanes may be used with the following structural unit:

R⁸₍₄₋ₓ₎Si(R⁹—NH—C(O)—N(R¹⁰—R¹¹)—C(O)—N(H)(R¹⁰R¹¹))ₓ

wherein R8 through R11 have the above definitions.

### (5) Wetting and Dispersing Additives

Another way to form a surface treated particle is by the use of wetting additives or dispersing additives which have a amphiphilic structure with particle affinic groups as well as sterically stabilising groups.

The concept of the dispersant—also designated, synonymously, as dispersing agent, dispersing additive, wetting agent, etc—as used herein designates, generally, substances which facilitate the dispersing of particles in a dispersion medium, especially by lowering the interfacial tension between the two components—particles to be dispersed, on the one hand, and dispersion media, on the other hand—and so by inducing wetting. Consequently there are a multiplicity of synonymous designations for dispersants (dispersing agents) in use, examples being dispersing additive, antisettling agent, wetting agent, detergent, suspending or dispersing assistant, emulsifier, etc.

It is more particularly a polymeric dispersant, especially a polymeric dispersant based on a functional polymer, optionally having a number-average molecular mass of at least 500 g/mol, in some embodiments at least 1000 g/mol, and in other embodiments at least 2000 g/mol. The dispersant may be selected from the group of polymers and copolymers having functional groups and/or groups with pigment affinity, alkylammonium salts of polymers and copolymers, polymers and copolymers having acidic groups, comb copolymers and block copolymers, such as block copolymers having groups with pigment affinity, especially basic groups with pigment affinity, optionally modified acrylate block copolymers, optionally modified polyurethanes, optionally modified and/or salified polyamines, phosphoric esters, ethoxylates, polymers and copolymers having fatty acid radicals, optionally modified polyacrylates, such as transesterified polyacrylates, optionally modified polyesters, such as acid-functional polyesters, polyphosphates, and mixtures thereof

Furthermore, it is possible in principle to use as dispersants in accordance herewith, any of the dispersants, surfactants, wetting agents, etc, that are known for that purpose.

By means of illustration and not limitation, useful dispersant compounds are described in publications EP 1 593 700 B1, EP 0 154 678 B1, EP 0 318 999 B1, EP 0 270 126 B1, EP 0 893 155 B1, EP 0 417 490 B1, EP 1 081 169 B1, EP 1 650 246 A1, EP 1 486 524 A1, EP 1 640 389 A1, EP 0 879 860 B1, WO 2005/097872 A1, and EP 1 416 019 A1, the respective disclosure content of which is hereby incorporated in full by reference.

### (6) Mixtures of the Aforementioned Surface Treatments.

Particle surfaces may be treated with mixtures of the aforementioned surface treatments (1) through (5).

A surface active agent, or surfactant, is a substance which lowers the surface tension of the medium in which it is dissolved, and/or the interfacial tension with other phases, and, accordingly, is positively adsorbed at the liquid/vapour and/or at other interfaces. The term surfactant is also applied correctly to sparingly soluble substances, which lower the surface tension of a liquid by spreading spontaneously over its surface.

The coating composition may contain at least one additional substance that is a typical coating additive, binder or cross-linking agent. By way of example but not limitation are wetting and dispersion additives and additives for controlling rheological properties, and also defoamers, emulsifiers, fillers, dyes, pigments, plasticisers, light stabilizers and catalysts.

A defoamer or an anti-foaming agent is a chemical additive that reduces and hinders the formation of foam in industrial process liquids.

A dispersant is any substance that is used to stabilize a dispersion or suspension of particles in a liquid.

Fillers are particles added to material to lower the consumption of more expensive pigments or binder material or to improve a property of the mixed material.

An emulsifier is an additive that promotes the formation of a stable mixture, or emulsion, of oil and water. Common emulsifiers include but are not limited to metallic soaps, certain animal and vegetable oils, and various polar compounds.

### E-Modulus

The e-modulus was measured by means of an indentation measurement in accordance to ASTM E2546. The e-modulus of the subject coatings is decreased by 10%, optionally by 20%, and further optionally by more than 20%, in comparison to the non particle containing coating material.

### Binder

The binder or resin of the coating is an ingredient used to bind together two or more other materials in mixtures. Its two principal properties are adhesion and cohesion. The binder of the coating may be a crosslinkable or non-crosslinkable resin.

A crosslinkable resin may be any crosslinkable resin suitable for use in waterborne, solvent-based, solvent-free, or powder coating compositions, including clearcoat coating compositions. As used herein, the term “crosslinkable resin” is intended to include not only those resins capable of being crosslinked upon application of heat but also those resins which are capable of being crosslinked without the application of heat. Examples of such crosslinkable resins include thermosetting acrylics, aminoplasts, urethanes, carbamates, carbonates, polyesters, epoxies, silicones and polyamides. These resins, when desired, may also contain functional groups characteristic of more than one class, as for example, polyester amides, urethane acrylates, carbamate acrylates, and the like.

Examples of resins and binders are given in EP 0832947B1, which is incorporated herein by reference.

Acrylic resins refer to the generally known addition polymers and copolymers of acrylic and methacrylic acids and their ester derivatives, acrylamide and methacrylamide, and acrylonitrile and methacrylonitrile. Examples of ester derivatives of acrylic and methacrylic acids include alkyl acrylates and alkyl methacrylates such as ethyl, methyl, propyl, butyl, hexyl, ethylhexyl and lauryl acrylates and methacrylates, as well as similar esters, having up to about 20 carbon atoms in the alkyl group. Also, hydroxyalkyl esters may readily be employed. Examples of such hydroxyalkyl esters include 2-hydroxyethyl acrylate, 2-hydroxypropyl acrylate, 2-hydroxyethyl methacrylate, 2-hydroxypropyl methacrylate, 3-hydroxypropyl-4-hydroxybutyl methacrylate, and mixtures of such esters having up to about 5 carbon atoms in the alkyl group. Where desired, various other ethylenically unsaturated monomers can be utilized in the preparation of acrylic resins, examples of which include: vinyl aromatic hydrocarbons optionally bearing halo substituents such as styrene, alpha-methyl styrene, vinyl toluene, alpha-chlorostyrene;

non-aromatic monoolefinic and di-olefinic hydrocarbons optionally bearing halo substituents, such as isobutylene, 2,3-dimethyl-l-hexene, 1,3-butadiene, chlorethylene, chlorobutadine and the like; and esters of organic and inorganic acids such as vinyl acetate, vinyl propionate, isopropenyl acetate, vinyl chloride, allyl chloride, vinyl alpha chloracetate, dimethyl maleate and the like.

The above polymerizable monomers are mentioned as representative of CH2═C<containing monomers which may be employed; but typically any copolymerizable monomer can be used.

Aminoplast resins refer to the generally known condensation products of an aldehyde with an amino-or amido-group containing substance, examples of which include the reaction products of formaldehyde, acetaldehyde, crotonaldehyde, benzaldehyde and mixtures thereof with urea, melamine or benzoguanimine In certain embodiments, aminoplast resins include the etherified (i.e. alkylated) products obtained from the reaction of alcohols and formaldehyde with urea, melamine, or benzoguanimine Examples of suitable alcohols for preparation of these etherified products include: methanol, ethanol, propanol, butanol, isobutanol, t-butanol, hexanol, benzylalcohol, cyclohexanol, 3-chloropropanol, and ethoxyethanol.

Urethane resins refer to the generally known thermosetting resins prepared from organic polyisocyanates and organic compounds containing active hydrogen atoms as found for example in hydroxyl, and amino moieties. Some examples of urethane resins typically utilized in one in one-component coating compositions include isocyanate-modified alkyd resins. Examples of systems based on urethane resins typically utilized as two-component coating compositions include an organic polyisocyanate or isocyanate-terminated prepolymer in combination with a substance containing active hydrogen such as in hydroxyl or amino groups together with a catalyst (for purposes of illustration but not limitation, an organotin salt such as dibutyltin dilaurate). The active hydrogen-containing substance of the second component typically is a polyester polyol, a polyether polyol, or an acrylic polyol known for use in such two-component urethane resin systems.

Polyester resins are generally known and are prepared by conventional techniques utilizing polyhydric alcohols and polycarboxylic acids. Examples of suitable polyhydric alcohols include: ethylene glycol; propylene glycol; diethylene glycol; dipropylene glycol; butylene glycol; glycerol; trimethylolpropane; pentaerythritol; sorbitol; 1,6-hexanediol; 1,4-cyclohexanediol; 1,4-cyclohexanedimethanol; 1,2-bis(hydroxyethyl)cyclohexane and 2,2-dimethyl-3-hydroxypropionate. Examples of suitable polycarboxylic acids include: phthalic acid; isophthalic acid; terephthalic acid;

trimellitic acid; tetrahydrophthalic acid; hexahydrophthalic acid; tetrachlorophthalic acid; adipic acid; azelaic acid; sebacic acid; succinic acid; maleic acid; glutaric acid; malonic acid; pimelic acid; succinic acid; 2,2-dimethylsuccinic acid; 3,3-dimethylglutaric acid; 2,2-dimethylglutaric acid; ;maleic acid; fumaric acid; and itaconic acid. Anhydrides of the above acids, where they exist can also be employed and are encompassed by the term “polycarboxylic acid”. In addition, substances which react in a manner similar to acids to form polyesters are also useful. Such substances include lactones such as caprolactone, propylolactone, and methyl caprolactone and hydroxy acids such as hydroxycaproic acid and dimethylol propionic acid. If a triol or higher hydric alcohol is used, a monocarboxylic acid such as acetic acid and benzoic acid may be used in the preparation of the polyester resin. Moreover, polyesters are intended to include polyesters modified with fatty acids or glyceride oils of fatty acids (i.e. conventional alkyd resins). Alkyd resins typically are produced by reacting the polyhydric alcohols, polycarboxylic acids, and fatty acids derived from drying, semi-drying, and non-drying oils in various proportions in the presence of a catalyst such as sulfuric acid, or a sulfonic acid to effect esterification. Examples of suitable fatty acids include saturated and unsaturated acids such as stearic acid, oleic acid, ricinoleic acid, palmitic acid, linoleic acid, linolenic acid licanic acid and elaeostearic acid.

Epoxy resins are generally known and refer to compounds or mixtures of compounds containing more than one 1,2-epoxy group (i.e. polyepoxides). The polyepoxides may be saturated or unsaturated, aliphatic, cycloaliphatic, aromatic or heterocyclic. Examples of suitable polyepoxides include the generally known polyglycidyl ethers of polyphenol and/or polyepoxides which are acrylic resins containing pendant and/or terminal 1,2-epoxy groups. Polyglycidyl ethers of polyphenols may be prepared, for example, by etherification of a polyphenol with epichlorohydrin or dichlorohydrin in the presence of an alkali. Examples of suitable polyphenols include: 1,1-bis(4-hydroxyphenyl)ethane; 2,2-bis(4-hydroxyphenyl)propane; 1,1-bis(4-hydroxyphenyl)isobutane; 2,2-bis(4-hydroxylphenyl)ethane; 2,2-bis(4-hydroxyphenyl)propane; 1,1-bis(4-hydroxyphenyl)isobutane; 2,2-bis(4-hydroxytertiarybutylphenyl)propane; bis(2-hydroxynapthyl)methane; and the hydrogenated derivatives thereof. The polyglycidyl ethers of polyphenols of various molecular weights may be produced, for example, by varying the mole ratio of epichlorohydrin to polyphenol.

Epoxy resins also include the polyglycidyl ethers of mononuclear polyhydric phenols such as the polyglycidyl ethers of resorcinol, pyrogallol, hydroquinone, and pyrocatechol.

Epoxy resins also include the polyglycidyl ethers of polyhydric alcohols such as the reaction products of epichlorhydrin or dichlorohydrin with aliphatic and cycloaliphatic compounds containing from two to four hydroxyl groups including, for example, ethylene glycol, diethylene glycol, triethylene glycol, dipropylene glycol, tripropylene glycol, propane dials, butane dials, pentane dials, glycerol, 1,2,6-hexane trial, pentaerythritol and 2,2 bis(4-hydroxycyclohexyl)propane.

Epoxy resins additionally include polyglycidyl esters of polycarboxylic acids such as the generally known polyglycidyl esters of adipic acid, phthalic acid, and the like.

Addition polymerized resins containing epoxy groups may also be employed. These polyepoxides may be produced by the addition polymerization of epoxy functional monomers such as glycidyl acrylate, glycidyl methacrylate and allyl glycidyl ether optionally in combination with ethylenically unsaturated monomers such as styrene, alpha-methyl styrene, alpha-ethyl styrene, vinyl toluene, t-butyl styrene, acrylamide, methacrylamide, acrylonitrile, methacrylonitrile, ethacrylonitrile, ethyl methacrylate, methyl methacrylate, isopropyl methacrylate, isobutyl methacrylate and isobornyl methacrylate.

The subject coating for a substrate may comprise resins and binders in which the above described particles, nanoparticles, and corrosion inhibitors are already incorporated, including but not limited to, during the polymerization process. The subject coating for a substrate may also comprise radiation curable coatings (such as by UV or IR light or other radiation), and/or powder coating resins and binders.

### Specific Embodiments

The addition of the nanoparticles described above under sufficient shear mixing can create a unique structure inside of the resin to enhance corrosion resistance. Typical resin systems for coatings in which the nanoparticles increase metal corrosion resistance include but are not limited to one component polyurethanes, two component polyurethanes, acrylics, oil modified urethanes, long oil alkyds, polyurethane dispersions, acrylic emulsions, epoxies, and water reducible alkyds.

Pre-dispersed nanoparticles from 5 nm to 80 nm in size of Al₂O₃ or SiO₂ or ZnO or combinations of above were dispersed using a wetting additive and or silicone treatments to stabilize and separate into discrete particles. These discrete particles have a high surface energy and impart a synergistic effect with resin matrixes or pigments filling the lower energy areas with the nanoparticles.

This interaction between nanoparticles and coating matrix may lead to self repair properties of the coating. This can be explained by lowering the E-modulus of a coating by incorporation of nanopartiocles, compared to a coating containing no nanoparticles. The lower E-modulus will result in higher flexibility and may lead to an immediate reflow effect.

In pigmented coatings the nanoparticles will enhance the packing of the pigments to create a denser film structure as compared to the pigmented coating that does not contain the nanoparticles.

### EXAMPLES

### Example 1

### Clear Long Oil Alkyd Resin Coating

| Formulation - Long Oil Alkyd | Control | Supplier |
|---|---|---|
| Nuplex 11-3323 Long Oil | 620 grams | Nuplex Resins |
| Alkyd | | |
| Mineral Spirits | 201 grams | JG Chemicals |
| 5% Calcium Drier | 10 grams | OMG Americas |
| 6% Cobalt Drier | 4 grams | OMG Americas |
| 18% Zinc Drier | 8 grams | OMG Americas |
| Dri-Rx | 1 gram | OMG Americas |
| Exkin #2 | 2 grams | OMG Americas |
| BYK 077 Defoamer | 2 grams | BYK USA Inc |
| BYK 302 Silicone Additive | 1 gram | BYK USA Inc |
| Total of Batch | 832 grams | |

The above formulation was mixed in a 1000 ml beaker using a Dispermat CV mixer. The resin and solvent were mixed together at 400 RPM for 2 minutes. All other additives were added while the resin solution was mixing. The batch was allowed to mix for 3 minutes at 400 RPM to allow all additives to mix into the batch. The batch was allowed to sit overnight.

| Long Oil Alkyd Batch | 100 grams | Supplier |
|---|---|---|
| 30% solid 10 nm A12O3 in | 2 grams | BYK USA Inc |
| D-60 Mineral Spirits | | |

The next day 100 grams was taken from the batch as the control. A second 100 grams was taken from the batch and to that was added 2 grams of the 30% Al₂O₃ in D-60 Mineral Spirits under mixing from a Dispermat CV mixer at 400 RPM for 2 minutes. Samples were then drawn down using a 76 μm (3 mil) draw down bar onto Q Panel S-46-1 smooth side panels. After 24 hours the panels had a dry film thickness of between 33 and 43 μm (1.3 and 1.7 mils). These panels were allowed to air dry for 7 days before putting them into the salt spray unit. They were scribed with an X and placed into the salt spray unit according to the ASTM B-117 method, and checked after 100 hrs, 150 hrs, 200 hrs and 250 hrs for corrosion.

While the control exhibited strong corrosion even after 100 hrs with rust creepage and lifting of the coating, the sample modified with 2% 10 nm predispersed Al₂O₃ showed almost no corrosion until 200 hrs. The panel with the nanoparticles in the coating was removed from the test after 250 hrs because it was showing creepage. With the alumina particles it was able to improve the corrosion by 150% over the control.

### Example 2

### Two Component Polyurethane Clearcoat Formula

| Clearcoat Part A | | Supplier |
|---|---|---|
| Joncryl 909 (71%) | 184.5 | BASF Resins |
| Methyl Amyl Ketone Solvent | 55.5 | Eastman Chemicals |
| Butyl Acetate Solvent | 9.3 | Dow Chemical |
| EEP Solvent | 32.1 | Eastman Chemicals |
| 40% CAB 55′-0.01 | 18.0 | Eastman Chemicals |
| 2% Catalyst T-12 | 0.6 | |
| BYK 306 | 0.6 | BYK USA Inc |
| | 300.6 | |
| Clearcoat Part B Activator | | |
| Desmodur N -3390 | 60.0 | Bayer Material Science |
| | 360.6 | |

The clearcoat formula was prepared in a 1000 ml beaker mixing at 600 RPM with a Dispermat CV mixer. The resin and solvent were mixed together for 2 minutes and the CAB and 2% catalyst were added last and allowed to sit for 1 hour. The Part B activator was added to the resin mix and mixed for 2 minutes and separated into 3 samples with 120 g each. The composition was completed after addition of a dispersion of surface treated silica according the following table:

| | Control | Sample 2A | Sample 2B | Supplier |
|---|---|---|---|---|
| 2.2 grams of 20% | | X | | Supplied by |
| solid 20 nm Silica | | | | BYK USA |
| surface treatment | | | | Inc |
| 1 | | | | |
| (NANOBYK- | | | | |
| 3651) | | | | |
| 2.2 grams of 25% | | | X | Supplied by |
| solid 20 nm Silica | | | | BYK USA |
| surface treatment | | | | Inc |
| 2 | | | | |
| (NANOBYK- | | | | |
| 3652) | | | | |

The dispersion of surface treated particles was added to each sample while mixing at 400 RPM with a Dispermat CV.

The mixtures were sprayed using a DeVilbiss J6A-502 Siphon Spray at 414 kPa (60 PSI) spray pressure on applied to Q Panel R-46 E coated panels. The panels were allowed to flash air dry for 15 minutes and placed into the oven for 40 minutes at 180° F. The coating had a dry film thickness between 38 and 46 μm (1.5 and 1.8 mils). They were allowed to cure for 7 days before putting panels into the salt spray. They were scribed with an X and placed into the salt spray unit according to the ASTM B-117 method. The panels were evaluated at 100 hrs of salt spray, 250 hrs of salt spray, 400 hrs of salt spray and a final evaluation given at 500 hrs. If there was rust creepage at the scribe mark, it was noted. The control panel started with creepage at 250 hrs.

At 400 hrs the predispersed 20 nm silica with a surface treatment 2 (Sample 2B) started to show creepage, considerably better. At the final review, one panel passed the 500 hrs point and that was the top coat with the predispersed 20 nm silica with surface treatment 1 (Sample 2A) post added to the resin.

### Example 3

### One Component Polyurethane Clear Baking Enamel

| 1K Clear Baking | | | | |
|---|---|---|---|---|
| Enamel | Control | Sample 3A | Sample 3B | Supplier |
| Joncryl 500 | 46.0 | 46.0 | 46.0 | BASF Resins |
| Methyl Amyl | 15.5 | 15.5 | 15.5 | Eastman |
| Ketone | | | | Chemicals |
| Xylene | 12.7 | 12.7 | 12.7 | JT Baker |
| | | | | Chemicals |
| Butanol | 2.6 | 2.6 | 2.6 | JT Baker |
| | | | | Chemicals |
| 40% CAB 551-0.01 | 6.7 | 6.7 | 6.7 | Eastman |
| | | | | Chemicals |
| Cymel 303 | 15.8 | 15.8 | 15.8 | Cytec |
| | | | | Industries |
| Pre mix at 400 RPM | | | | |
| for 2 minutes | | | | |
| BYK Catalyst 460 | 0.6 | 0.6 | 0.6 | BYK USA Inc |
| Mix for 2 minutes at | | | | |
| 400 RPM | | | | |
| BYK 306 | 0.2 | 0.2 | 0.2 | BYK USA Inc |
| 20% solid 20 nm | | 2.0 | | BYK USA Inc |
| Silica with surface | | | | |
| treatment 1 | | | | |
| (NANOBYK-3651) | | | | |
| 25% solid 20 nm | | | 2.0 | BYK USA Inc |
| Silica with surface | | | | |
| treatment 2 | | | | |
| (NANOBYK-3652) | | | | |

The coating composition was made in a 1000 ml beaker using a Dispermat CV and mixing the solvent, additives, and resin for 2 minutes at 400 RPM before adding the catalyst. The nano silica with surface treatment 1 was added to the Sample 3A and nano silica with surface treatment 2 was added to the Sample 3B batches, while the resin solution was mixing on a Dispermat CV at 400 RPM for 2 minutes. The batches were allowed to sit for 1 hour before spraying the panels.

The one component system was sprayed using a DeVilbiss J6A-502 Siphon Spray at 414 kPa (60 PSI) spray pressure applied to Q Panel R-46 E coated panels. The panels were allowed to flash air dry for 15 minutes and put into the oven for 20 minutes at 300° F. The coating had a dry film thickness between 38 and 46 μm (1.5 and 1.8 mils). They were allowed to cure for 7 days before putting panels into the salt spray. They were scribed in X fashion and placed into the salt spray unit according to the ASTM B-117 method. The panels were evaluated at 100 hrs of salt spray, 250 hrs of salt spray, 400 hrs of salt spray and a final evaluation given at 500 hrs. If there was rust creepage at the scribe mark, it was noted. The control started with creepage at 250 hrs. At 400 hrs the predispersed 20 nm silica with surface treatment 2 (Sample 3B) started to show creepage, considerably better. At the final review one panel passed 500 hrs point and that was the top coat with predispersed 20 nm silica with surface treatment 1 (Sample 3A) post added to the resin.

This demonstrated that a one component polyurethane could be just as successful as a two component polyurethane resin because the nanoparticles were used to form a structure sufficient to enhance corrosion resistance.

### Example 4

### EPON 828

| Epoxy Formulation | Control | Sample 4 | Supplier |
|---|---|---|---|
| Epon 828 | 50 grams | 50 grams | Hexion |
| | | | Chemicals |
| Ancamine 1618 | 30 grams | 30 grams | Air Products |
| BYK A-530 air release | 1 gram | 1 gram | BYK USA Inc |
| surface treated (20 nm) | | | BYK USA Inc |
| silica dispersed in | | | |
| TMPTA monomer | | 2 grams | |
| (50% silica content)* | | | |

*surface treatment with 3-methacryloxypropyltrimethoxysilane

The coating material was mixed together in a 125 ml beaker each with a Dispermat CV at 200 RPM for 4 minutes. The surface treated nano silica was added under mixing for 2 minutes at 200 RPM. The batches were allowed to sit for 1 hour before applying the coating.

An Epoxy coating (Epon 828) that was applied to a Q Panel S-46-1 smooth side with a wire wound bar. The thickness of the coating is 1016 μm (40 mils) thick which would be similar to a coating applied to a bridge structure. The panels have a dry film thickness of 889 to 940 μm (35 to 37 mils). This panel was allowed to air dry for 14 days before putting it into the salt spray. Panels were checked at 100 hrs, 200 hrs and 300 hrs. The control showed rusting and creepage at 100 hrs. The panel with nanoparticles showed no rusting or creepage after 100 hours salt spray. The control coating showed medium rust and creepage after 200 hrs. The panel with the nano started to show a little lifting of the coating but no rust build-up or creepage after 300 hours of salt spray. This is considered a success and an improvement of well over 300 percent over the control. A standard clear epoxy coated panel fails after 100 hrs.

This demonstrated that the pre dispersed nanoparticles in a monomer enhanced the corrosion resistance of the epoxy coating system by developing a network within the resin and increasing its resistance to corrosion.

### Example 5

### Epon 828 with Red Iron Oxide Pigment

| Epoxy Formulation | Control | Sample 5 | Supplier |
|---|---|---|---|
| Epon 828 | 50 grams | 50 grams | Hexion |
| | | | Chemicals |
| Ancamine 1618 | 30 grams | 30 grams | Air Products |
| BYK A-530 air release | 1 gram | 1 gram | BYK USA Inc |
| surface treated (20 nm) | | 2 grams | BYK USA Inc |
| silica dispersed in | | | |
| TMPTA monomer | | | |
| (50% silica content)* | | | |
| Nuodex 888 Red Oxide | 5 grams | 5 grams | Evonik |
| paste | | | Industries |

*surface treatment with 3-methacryloxypropyltrimethoxysilane

The batches were mixed together in a 125 ml beaker with a Dispermat CV at 200 RPM for 4 minutes. The nano silica was added under mixing for 2 minutes at 200 RPM. The red iron oxide paste was added under mixing for 4 minutes at 200 RPM. The batches were allowed to sit for 30 minutes before applying the coating. An Epoxy coating (Epon 828) with 5% red iron oxide paste post added was applied to a Q panel S-46-1 smooth side with a wire wound bar. The thickness of the coating was 1016 μm (40 mils) thick which would be similar to a coating applied to a bridge structure. The panels had a dry film thickness of 889 to 940 μm (35 to 37 mils). This panel was allowed to air dry for 14 days prior to placing it into the salt spray. Panels were checked at 100 hrs, 200 hrs and 300 hrs.

The control showed a little rusting and creepage at 100 hrs. The panel with the nanoparticles showed no rusting or creepage after 100 hours of salt spray. The control coating showed a little rusting and medium creepage after 200 hrs. The panel with the nanoparticles after 200 hrs showed almost no sign of rusting and no creepage. Even though epoxy is not normally used as an anti corrosive coating, this was considered a success, with better than a 100% improvement over the control panel. A standard pigmented epoxy coated panel fails after 200 hrs as well.

This demonstrated again that the pre dispersed nanoparticles in a monomer enhanced the corrosion resistance of this epoxy pigmented coating system by developing a network within the resin and pigments and increasing its resistance to corrosion.

### Example 6

### Direct to metal Clear Water Reducible Alkyd Formulation

| Water Reducible | | | | |
|---|---|---|---|---|
| Alkyd | Control | Sample 6A | Sample 6B | Supplier |
| Uradil AZ 554Z- | 76.5 | 76.5 | 76.5 | supplied by |
| 50 resin | | | | DSM Resins |
| Water | 20.0 | 20.0 | 20.0 | |
| Acrysol RM 8W | 2.0 | 2.0 | 2.0 | supplied by |
| | | | | Dow |
| | | | | Chemical |
| BYK-348 | 1.0 | 1.0 | 1.0 | supplied by |
| | | | | BYK USA Inc |
| Additol VXW | 0.5 | 0.5 | 0.5 | supplied by |
| 4940 | | | | Cytec |
| | | | | Industries |
| Total | 100 | 100 | 100 | |
| 40% Solid 40 nm | | 2.0 | 1.0 | supplied by |
| ZnO | | | | |
| | | | | BYK USA Inc |
| 40% Solid 10 nm | | | 1.0 | supplied by |
| A1203 | | | | BYK USA Inc |

The above formulation was mixed in a 1000 ml beaker using a Dispermat CV mixer. The resin and water were mixed together at 400 RPM for 2 minutes. All other additives and drier were added while the resin solution was mixing. The batch was allowed to mix for 2 minutes at 400 RPM to allow all additives and drier to mix into the batch. The batch was allowed to sit for 30 minutes. The water reducible alkyd formulation was separated into 100 gram samples. The sample 6A was modified with 2% 40 nm pre-dispersed ZnO, and the sample 6B was modified with 1% 40 nm pre-dispersed ZnO and 1% 10 nm Al₂O₃.

Samples were then drawn down using a 152 μm (6 mil) draw down bar onto Q Panel S-46-1 smooth side panel. After 24 hours the panels had a dry film thickness of between 96.5 and 102 μm (3.8 and 4 mils). These panels were allowed to air dry for 7 days before putting into the salt spray unit. They were scribed with an X and placed into the salt spray unit according to the ASTM B-117 method, and checked after 100 hrs, 200 hrs and 400 hrs for corrosion.

The control exhibited strong corrosion after only 100 hrs with rust and creepage and lifting of the coating. The sample 6A modified with 2% 40 nm pre-dispersed ZnO showed no corrosion at 100 hrs. The sample 6B modified with 1% 40 nm pre-dispersed ZnO and 1% 10 nm Al₂O₃ showed no rust or creepage at 100 hrs.

The sample 6A modified with 2% 40nm pre-dispersed ZnO showed no rust or creepage at 200 hrs. The sample 6B modified with 1% 40 nm pre-dispersed ZnO and 1% 10 nm Al₂O₃ showed light rust or no creepage at 200 hrs. The sample 6A showed light rust and light creepage at 300 hrs. The sample 6B showed light rust or creepage at 300 hrs. The sample 6A showed light rust and light creepage at 400 hrs. This is considered a success. The sample 6B showed light rust and medium creepage at 400 hrs. In both nanoparticle formulations there was a 400 percent improvement in the salt spray resistance.

### Example 7

### Two Component Polyurethane Clearcoat using Different Solvents and Isocyanate

| Clearcoat Part A | | Supplier |
|---|---|---|
| Joncryl 909 (71%) | 242.0 | BASF Resins |
| Methyl Amyl Ketone Solvent | 74.0 | Eastman Chemicals |
| Butyl Acetate Solvent | 12.4 | Dow Chemical |
| EEP Solvent | 42.0 | Eastman Chemicals |
| 40% CAB 55′-0.01 | 24.8 | Eastman Chemicals |
| Tinuvin 1130 | 1.6 | Ciba |
| Tinuvin 292 | 2.4 | Ciba |
| BYK 306 | 0.8 | BYK USA Inc |
| | 400.0 | |
| Clearcoat Part B Activator | | |
| Desmodur N -75 | 88.0 | Bayer Material Science |
| | 488.0 | |

The clearcoat formula was prepared in a 1000 ml beaker mixing at 600 RPM with a Dispermat CV mixer. The resin and solvent were mixed together for 2 minutes and the CAB and tinuvin were added last and allowed to sit for 1 hour. The Part B activator was added to the resin mix and mixed for 2 minutes, and separated into 4 samples with 122 g each. The composition was completed after addition of a dispersion of surface treated silica according the following table:

| | Control | Sample 7A | Sample 7B | Sample 7C | Supplier |
|---|---|---|---|---|---|
| 2.4 grams of | | X | | | BYK |
| 20% solid 20 nm | | | | | USA |
| Silica with | | | | | Inc |
| surface | | | | | |
| treatment 1 | | | | | |
| (NANOBYK- | | | | | |
| 3651) | | | | | |
| 2.4 grams of | | | X | | BYK |
| 25% solid 20 nm | | | | | USA |
| Silica with | | | | | Inc |
| surface | | | | | |
| treatment 2 | | | | | |
| (NANOBYK- | | | | | |
| 3652) | | | | | |
| 2.4 grams of | | | | X | BYK |
| 25% solid 20 nm | | | | | USA |
| Silica with | | | | | Inc |
| surface | | | | | |
| treatment 3 | | | | | |
| (NANOBYK- | | | | | |
| 3650) | | | | | |

The dispersion of surface treated particles was added to each sample while mixing at 400 RPM with a Dispermat CV for 2 minutes.

These mixtures were drawn down with a 7602 μm (3 mil) drawdown bar to a Q Panel R-46 E coated panel. The panels were allowed to flash air dry for 1 hour and put into the oven for 50 minutes at 175° F. The coating had a dry film thickness between 38 and 46 μm (1.5 and 1.8 mils). They were allowed to cure for 7 days before putting panels into the salt spray. They were scribed with an X and placed into the salt spray unit according to the ASTM B-117 method.

The panels were evaluated at 100 hrs of salt spray, 250 hrs of salt spray, 400 hrs of salt spray and a final evaluation given at 550 hrs. If there was rust or creepage at the scribe mark, it was noted. The control started with light rust and little creepage at 250 hrs. At 250 hrs the pre-dispersed 20 nm silica with a surface treatment 1 (Sample 7A) showed no rust but light creepage. At 250 hrs the pre-dispersed 20 nm silica with a surface treatment 2 (Sample 7B) showed no rust and no creepage. At 250 hrs the pre-dispersed 20 nm silica with a surface treatment 3 (Sample 7C) showed no rust and no creepage.

At 400 hrs the pre-dispersed 20 nm silica with a surface treatment 1 (Sample 7A) started to show light rust and little creepage. At 400 hrs the pre-dispersed 20 nm silica with a surface treatment 2 (Sample 7B) showed no rust and no creepage. At 400 hrs the pre-dispersed 20 nm silica with a surface treatment 3 (Sample 7C) showed no rust and no creepage. At 550 hrs the pre-dispersed 20 nm silica with a surface treatment 1 (Sample 7A) started to show medium rust and light creepage. This was a 200% improvement over control. At 550 hrs the pre-dispersed 20 nm silica with a surface treatment 2 (Sample 7B) showed light rust and light creepage. This was considered a success. At 550 hrs the pre-dispersed 20 nm silica with a surface treatment 3 (Sample 7C) showed very light rust and light creepage. This was considered an excellent success.

### Example 8

### Paint Formulation: Control

| Sample | 8.1.1 | 8.1.2 | 8.1.3 | 8.1.4 |
|---|---|---|---|---|
| Epikote 1001X75 | 23.0 | 23.0 | 23.0 | 23.0 |
| Xylene | 6.0 | 6.0 | 6.0 | 6.0 |
| Dowanol PM | 5.0 | 5.0 | 5.0 | 5.0 |
| Disperbyk-142 | 0.8 | 0.8 | 0.8 | 0.8 |
| B-A530 | 0.5 | 0.5 | 0.5 | 0.5 |
| B-320 | 0.2 | 0.2 | 0.2 | 0.2 |
| Blanfixe N | 14.0 | 21.5 | 21.5 | 24.0 |
| Micron talc AT1 | 12.0 | 19.5 | 19.5 | 22.0 |
| Bayferrox 130M | 4.7 | 4.7 | 4.7 | 4.7 |
| Heucophos ZPA | 20.0 | — | — | — |
| Zinc oxide | — | 5.0 | — | — |
| Silica | — | — | 5.0 | — |
| Xylene | 10.0 | 10.0 | 10.0 | 10.0 |
| Dowanol PM | 3.8 | 3.8 | 3.8 | 3.8 |
| Epikure 3155 | 8.6 | 8.6 | 8.6 | 8.6 |

### Used Predispersed Nanoparticles

### NANOBYK-3610:

Dispersion of 30% surface treated alumina nanoparticles in methoxypropyl acetate

### NANOBYK-3651:

Dispersion of 20% surface treated silica nanoparticles methoxypropyl acetate

### NANOBYK-3841:

Dispersion of 40% zinc oxide nanoparticles in methoxypropylacetate

### BYK-LPX 21441:

Dispersion of 30% alumina nanoparticles in methoxypropyl acetate

### BYK-LPX21442:

Dispersion of 30% Boemite nanoparticles in methoxypropyl acetate

### BYK-LPX21457:

Dispersion of 20% cerium oxide nanoparticles in methoxypropyl acetate
Paint Formulations: with Nano-Additives

| | Sample | | | | | |
|---|---|---|---|---|---|---|
| | 8.2.1 | 8.2.2 | 8.2.3 | 8.2.4 | 8.2.5 | 8.2.6 |
| Epikote 1001X75 | 23.0 | 23.0 | 23.0 | 23.0 | 23.0 | 23.0 |
| Xylene | 6.0 | 6.0 | 6.0 | 6.0 | 6.0 | 6.0 |
| Dowanol PM | 5.0 | 5.0 | 5.0 | 5.0 | 5.0 | 5.0 |
| Disperbyk-142 | 0.8 | 0.8 | 0.8 | 0.8 | 0.8 | 0.8 |
| B-A530 | 0.5 | 0.5 | 0.5 | 0.5 | 0.5 | 0.5 |
| B-320 | 0.2 | 0.2 | 0.2 | 0.2 | 0.2 | 0.2 |
| Blanfixe N | 24.0 | 24.0 | 24.0 | 24.0 | 24.0 | 24.0 |
| Micron talc AT1 | 22.0 | 22.0 | 22.0 | 22.0 | 22.0 | 22.0 |
| Bayferrox 130M | 4.7 | 4.7 | 4.7 | 4.7 | 4.7 | 4.7 |
| Dowanol PM | 3.8 | 3.8 | 3.8 | 3.8 | 3.8 | 3.8 |
| Nanobyk-3610 30% | 1.67 | 3.33 | 6.67 | — | — | — |
| Nanobyk-3651 20% | — | — | — | 2.5 | 5.0 | 10.0 |
| Xylene | 8.33 | 6.67 | 3.33 | 7.5 | 5.0 | — |
| Epikure 3155 | 8.6 | 8.6 | 8.6 | 8.6 | 8.6 | 8.6 |

| | Sample | | | | | |
|---|---|---|---|---|---|---|
| | 8.2.7 | 8.2.8 | 8.2.9 | 8.2.10 | 8.2.11 | 8.2.12 |
| Epikote 1001X75 | 23.0 | 23.0 | 23.0 | 23.0 | 23.0 | 23.0 |
| Xylene | 6.0 | 6.0 | 6.0 | 6.0 | 6.0 | 6.0 |
| Dowanol PM | 5.0 | 5.0 | 5.0 | 5.0 | 5.0 | 5.0 |
| Disperbyk-142 | 0.8 | 0.8 | 0.8 | 0.8 | 0.8 | 0.8 |
| B-A530 | 0.5 | 0.5 | 0.5 | 0.5 | 0.5 | 0.5 |
| B-320 | 0.2 | 0.2 | 0.2 | 0.2 | 0.2 | 0.2 |
| Blanfixe N | 24.0 | 24.0 | 24.0 | 24.0 | 24.0 | 24.0 |
| Micron talc AT1 | 22.0 | 22.0 | 22.0 | 22.0 | 22.0 | 22.0 |
| Bayferrox 130M | 4.7 | 4.7 | 4.7 | 4.7 | 4.7 | 4.7 |
| Dowanol PM | 3.8 | 3.8 | 3.8 | 3.8 | 3.8 | 3.8 |
| LPX-21457 20% | 2.5 | 5.0 | 10.0 | — | — | — |
| Nanobyk-3841 40% | — | — | — | 1.25 | 2.5 | 5.0 |
| Xylene | 7.5 | 5.0 | — | 8.75 | 7.5 | 5.0 |
| Epikure 3155 | 8.6 | 8.6 | 8.6 | 8.6 | 8.6 | 8.6 |

| | Sample | | | | | |
|---|---|---|---|---|---|---|
| | 8.13 | 8.2.14 | 8.2.15 | 8.2.16 | 8.2.17 | 8.2.18 |
| Epikote 1001X75 | 23.0 | 23.0 | 23.0 | 23.0 | 23.0 | 23.0 |
| Xylene | 6.0 | 6.0 | 6.0 | 6.0 | 6.0 | 6.0 |
| Dowanol PM | 5.0 | 5.0 | 5.0 | 5.0 | 5.0 | 5.0 |
| Disperbyk-142 | 0.8 | 0.8 | 0.8 | 0.8 | 0.8 | 0.8 |
| B-A530 | 0.5 | 0.5 | 0.5 | 0.5 | 0.5 | 0.5 |
| B-320 | 0.2 | 0.2 | 0.2 | 0.2 | 0.2 | 0.2 |
| Blanfixe N | 24.0 | 24.0 | 24.0 | 24.0 | 24.0 | 24.0 |
| Micron talc AT1 | 22.0 | 22.0 | 22.0 | 22.0 | 22.0 | 22.0 |
| Bayferrox 130M | 4.7 | 4.7 | 4.7 | 4.7 | 4.7 | 4.7 |
| Dowanol PM | 3.8 | 3.8 | 3.8 | 3.8 | 3.8 | 3.8 |
| LP-X 21441 30% | 1.67 | 3.33 | 6.67 | — | — | — |
| LP-X 21442 30% | — | — | — | 1.67 | 3.33 | 6.67 |
| Xylene | 8.33 | 6.67 | 3.33 | 8.33 | 6.67 | 3.33 |
| Epikure 3155 | 8.6 | 8.6 | 8.6 | 8.6 | 8.6 | 8.6 |

### Paint Application

Applied 2K epoxy paint on back side of Sa 2.5 blasted steel panels. Kept panels at room temperature over night, put into 50° C. oven for 8 hours for drying.

Mixed additive and hardener before application, 2000 rpm for 3 minutes, left the paint for 5 minutes, then filtered by 80μ sieve.

Cleaned Sa 2.5 blasted steel panel by brush (to remove surface dust). The paint was applied by air-spraying (around 100 μm dft after drying).

Closed each panel edge by 2K epoxy.

### Drying Condition

Kept panels at room temperature for 2 weeks.

### Salt Spray Test

Coated panels were put into salt-spray chamber for 720 hours (ISO 21944 C5 I Medium and C5 M Medium and IM 2) according to Std DIN EN ISO 9227.

### Corrosion Resistance Test Result Evaluation

After Salt-spray test/Water immersion test/Condensation test Evaluation according to ASTM D610, D714, D1654.

### Additional Test

Cross-cut to check adhesion according to DIN EN ISO 2409/ASTM 3359. Posi-test to check adhesion according to ISO 4624.

Salt Spray Test 720 hrs

| | | | Underfilm | | | | | |
|---|---|---|---|---|---|---|---|---|
| | | | corrosion | | | Adhesion | | |
| | | | creeption dw | Field | Field | | Pull- | Cross |
| Additive | Description | dft (μm) | (mm) | Corrosion | Blistering | Pull-off 1 | off 2 | cut |
| Control-1 | With zinc | 94.1 | 5.0 | 9 | No blisters | 2.41 | 2.37 | 5B |
| | phosphate | 108 | 4.5 | 9 | No blisters | 2.05 | 1.73 | 5B |
| | 8.1.1 | 101 | 4.5 | 9 | No blisters | 2.43 | 2.39 | 5B |
| Control-2 | With microsized | 75.7 | 3.5 | 6 | 6MD | 0.66 | 0.90 | 2B |
| | zinc oxide | 96.3 | 3.0 | 6 | 6MD | 0.67 | 1.07 | 1B |
| | 8.1.2 | 121 | 3.0 | 6 | 6MD | 1.19 | 1.26 | 1B |
| Control-3 | With microsized | 108 | 0.5 | 3 | 4M | 0.45 | 0.93 | 1B |
| | silica | 103 | 3.5 | 3 | 4M | 0.58 | 0.95 | 1B |
| | 8.1.3 | 84.3 | 3.0 | 3 | 4M | 0.69 | 0.85 | 1B |
| Control-4 | No nano additive | 105 | 4.0 | 3 | 4M | 0.62 | 0.72 | 1B |
| | inside | 88.3 | 3.5 | 3 | 4M | 1.04 | 0.91 | 1B |
| | 8.1.4 | 79.3 | 4.0 | 3 | 4M | 0.99 | 0.95 | 1B |
| Nanobyk- | 0.5% active | 69.1 | 5.5 | 4 | 4M | 0.80 | 0.82 | 3B |
| 3610 | Substance | 69.1 | 4.5 | 4 | 4F | 0.88 | 1.08 | 3B |
| | 8.2.1 | 68.6 | 4.5 | 4 | 4F | 0.81 | 0.91 | 3B |
| | 1.0% active | 91.3 | 4.5 | 5 | 4F | 1.06 | 1.93 | 1B |
| | substance | 102 | 4.5 | 5 | 4F | 2.13 | 2.30 | 1B |
| | 8.2.2 | 82.9 | 5.0 | 5 | 4F | 2.04 | 1.87 | 1B |
| | 2.0% active | 80.4 | 5.0 | 5 | 4F | 0.55 | 0.79 | 1B |
| | substance | 72.4 | 4.5 | 5 | 4F | 0.88 | 0.86 | 1B |
| | 8.2.3 | 76.3 | 4.0 | 6 | 6F | 0.72 | 0.84 | 2B |
| Nanobyk- | 0.5% active | 104 | 2.0 | 9 | No blisters | 1.55 | 1.40 | 5B |
| 3651 | substance | 149 | 2.0 | 9 | No blisters | 1.86 | 2.27 | 5B |
| | 8.2.4 | 111 | 5.0 | 9 | No blisters | 1.75 | 1.22 | 5B |
| | 1.0% active | 141 | 4.0 | 9 | No blisters | 1.37 | 2.28 | 1B |
| | substance | 121 | 2.5 | 10 | No blisters | 2.09 | 2.25 | 5B |
| | 8.2.5 | 138 | 3.0 | 10 | No blisters | 2.02 | 2.28 | 1B |
| | 2.0% active | 83.3 | 2.0 | 7 | 4F | 0.87 | 0.73 | 1B |
| | substance | 97.8 | 5.0 | 7 | 4F | 1.17 | 1.01 | 1B |
| | 8.2.6 | 108 | 5.0 | 7 | 4F | 1.50 | 1.16 | 1B |
| LP-X | 0.5% active | 132 | 3.5 | 7 | 2F | 2.09 | 1.97 | 5B |
| 21457 | substance | 105 | 3.5 | 5 | 2F | 0.89 | 1.12 | 1B |
| | 8.2.7 | 96.7 | 3.5 | 5 | 4F | 1.98 | 1.02 | 1B |
| | 1.0% active | 112 | 4.0 | 6 | 4F | 0.95 | 1.13 | 1B |
| | substance | 106 | 4.0 | 5 | 4F | 1.17 | 1.16 | 1B |
| | 2.2.8 | 102 | 3.5 | 5 | 4F | 1.18 | 1.15 | 1B |
| | 2.0% active | 125 | 3.0 | 6 | 4F | 1.18 | 1.11 | 1B |
| | substance | 123 | 3.0 | 7 | 4F | 1.84 | 1.95 | 1B |
| | 8.2.9 | 108 | 3.5 | 6 | 4F | 1.23 | 1.01 | 1B |
| Nanobyk- | 0.5% active | 95.7 | 3.0 | 6 | 4F | 0.78 | 1.11 | 1B |
| 3841 | substance | 125 | 3.0 | 7 | 4F | 1.37 | 1.26 | 1B |
| | 8.2.10 | 92.5 | 3.0 | 5 | 4F | 1.02 | 1.04 | 1B |
| | 1.0% active | 87.7 | 3.0 | 5 | 4F | 1.10 | 1.02 | 1B |
| | substance | 99.1 | 3.0 | 5 | 4F | 1.22 | 0.99 | 1B |
| | 8.2.11 | 93.9 | 3.0 | 5 | 4M | 0.92 | 1.02 | 1B |
| | 2.0% active | 92.3 | 3.0 | 5 | 4F | 1.17 | 1.26 | 1B |
| | substance | 110 | 3.5 | 5 | 4M | 1.15 | 0.99 | 1B |
| | 8.2.12 | 115 | 3.5 | 6 | 4F | 0.91 | 1.26 | 1B |
| LP-X | 0.5% active | 78.5 | 3.0 | 4 | 4M | 0.77 | 1.03 | 2B |
| 21441 | substance | 89.7 | 3.5 | 5 | 4M | 1.06 | 1.19 | 2B |
| | 8.2.13 | 93.8 | 3.0 | 5 | 4M | 0.76 | 1.20 | 5B |
| | 1.0% active | 94.1 | 3.0 | 5 | 6MD | 0.81 | 1.12 | 2B |
| | substance | 94.3 | 3.0 | 5 | 6MD | 1.12 | 0.99 | 2B |
| | 8.2.14 | 92.0 | 2.5 | 5 | 6MD | 1.01 | 1.08 | 1B |
| | 2.0% active | 74.3 | 1.0 | 6 | 6D | 0.95 | 1.48 | 2B |
| | substance | 73.6 | 0.5 | 6 | 6D | 1.31 | 1.12 | 2B |
| | 8.2.15 | 79.7 | 1.0 | 6 | 6D | 1.18 | 1.08 | 2B |
| LP-X | 0.5% active | 73.8 | 3.0 | 6 | 4F | 1.14 | 1.06 | 5B |
| 21442 | substance | 95.4 | 3.5 | 6 | 4F | 1.39 | 1.29 | 5B |
| | 8.2.16 | 82.5 | 3.5 | 5 | 4F | 0.95 | 1.06 | 5B |
| | 1.0% active | 81.2 | 3.0 | 5 | 2MD | 0.84 | 0.79 | 1B |
| | substance | 87.7 | 3.5 | 4 | 2MD | 0.66 | 1.08 | 2B |
| | 8.2.17 | 98.3 | 3.5 | 5 | 2M | 1.64 | 1.31 | 1B |
| | 2.0% active | 95.2 | 3.0 | 6 | 4D | 1.05 | 1.18 | 1B |
| | substance | 85.7 | 3.0 | 5 | 4D | 0.86 | 1.22 | 1B |
| | 8.2.18 | 82.5 | 2.5 | 6 | 4D | 0.73 | 1.29 | 1B |

Salt Spray Test Note:
Underfilm corrosion creepage measured with one side failure width beside scribed line (unit in mm).
Field corrosion measured over unscribed area, rating according to % of failed area. 10 is best, 0 is worst
Field blistering measured over unscribed area, rating according of size and frequency of blisters. 2 indicate bigger blisters, 8 indicates finest blisters. F indicates frequency FEW, M indicates frequency MEDIUM, MD indicates frequency MEDIUM DENSE, and D indicates frequency DENSE.
Cross cut 5B indicates no area removed, 0B indicates more than 65% area removed.

After 720 hrs of salt spray test, those panels containing NANOBYK 3651 showed a significantly improved anti-corrosion performance compared to no anticorrosive pigment containing coatings. Its underfilm corrosion creepage was even better than zinc phosphate containing coatings. There was also no negative influence on adhesion to blasted steel after salt-spray.

### Example 9

### Air-Drying Short-Oil Alkyd Primer

Control formulation with Corrosion Inhibitor

| Alkydal F 26 (60% in | 40.0 |
|---|---|
| Xylene) | |
| ANTI-TERRA 204 | 0.7 |
| Dowanol PM | 2.5 |
| Dipenten | 1.9 |
| Glycol butyl ester | 0.6 |
| White Spirit K 30 | 4.5 |
| Aerosil 200 | 0.3 |
| Bayferrox 140M | 13.3 |
| Talkum AT 1 | 6.2 |
| Zinc Oxide, microscale | 11.3 |
| (−2.5 μm) | |
| Blanc fixe N | 5.2 |
| Heucorin RZ | 0.7 |
| Zinc phosphate ZP 10 | 6.3 |
| Grinding condition: 20 minutes, 17 m/s, | |
| 1 mm glass beads 1:1 | |
| Exkin 2 | 0.6 |
| Xylene | 5.6 |
| Co-octoate (12%) | 0.1 |
| Mn-octoate (6%) | 0.2 |
| | 100.0 |

Coating Formulation to be used with ZnO Nanoparticles (NANOBYK 3841)

| Alkydal F 26 (60% in Xylene) | 40.0 |
|---|---|
| ANTI-TERRA 204 | 0.7 |
| Dowanol PM | 2.5 |
| Dipenten | 1.9 |
| Glycol butyl ester | 0.6 |
| White Spirit K 30 | 4.5 |
| Aerosil 200 | 0.3 |
| Bayferrox 140M | 23.1 |
| Talkum AT 1 | 10.8 |
| Zinc Oxide, microscale | 0.0 |
| (−2.5pm) | |
| Blanc fixe N | 9.0 |
| Heucorin RZ | 0.0 |
| Zinc phosphate ZP 10 | 0.0 |
| Grinding condition: 20 minutes, 17 m/s, | |
| 1 mm glass beads 1:1 | |
| Exkin 2 | 0.6 |
| Xylene | 5.6 |
| Co-octoate (12%) | 0.1 |
| Mn-octoate (6%) | 0.2 |
| | 100.0 |

ZnO nanoparticles were used at levels of 0.5 wt. % and 1.0 wt. % based on total formulation.

Salt Spray Test

| | | | | | | | Salt Spray Test | | | | | | | |
|---|---|---|---|---|---|---|---|---|---|---|---|---|---|---|
| | | Water Storage | | | | | Measurement of Creepage (1000 hrs) | | | | | | | |
| | | Weight % | | | | | | | | | | | Ave. Value | Wd |
| | | Particles | 24 hrs | 300 hrs | 600 hrs | 1000 hrs | 1 | 2 | 3 | 4 | 5 | 6 | (1-6)t | [cm]* |
| Control | Panel 1 | 0 | OK | OK | i.O. | i.O. | 1.8 | 2.2 | 2.0 | 1.6 | 1.7 | 2.2 | 1.9 | 0.91 |
| | Panel 2 | 0 | OK | OK | i.O. | i.O. | 1.7 | 2.0 | 2.0 | 1.7 | 1.4 | 1.7 | 1.8 | 0.83 |
| | Panel 3 | 0 | OK | OK | i.O. | i.O. | 2.5 | 2.2 | 1.6 | 1.7 | 1.7 | 2.2 | 2.0 | 0.94 |
| Control with | Panel 1 | 18.3 | OK | OK | i.O. | i.O. | 0.8 | 0.6 | 1.0 | 0.7 | 0.4 | 0.3 | 0.6 | 0.27 |
| corrosion | Panel 2 | 18.3 | OK | OK | i.O. | i.O. | 0.8 | 0.6 | 0.9 | 1.1 | 1.2 | 0.6 | 0.9 | 0.38 |
| inhibitor | Panel 3 | 18.3 | OK | OK | i.O. | i.O. | 1.2 | 0.7 | 0.6 | 1.0 | 0.6 | 0.5 | 0.8 | 0.33 |
| Nanobyk-3841 | Panel 1 | 0.5% | OK | OK | i.O. | i.O. | 1.0 | 0.7 | 0.8 | 0.3 | 0.5 | 0.6 | 0.7 | 0.28 |
| | Panel 2 | 0.5% | OK | OK | i.O. | i.O. | 0.4 | 0.7 | 0.4 | 0.5 | 0.3 | 0.8 | 0.5 | 0.21 |
| | Panel 1 | 1.0% | OK | OK | i.O. | i.O. | 0.8 | 0.9 | 0.4 | 0.5 | 0.9 | 0.6 | 0.7 | 0.29 |
| | Panel 2 | 1.0% | OK | OK | i.O. | i.O. | 0.4 | 0.3 | 0.6 | 0.5 | 0.7 | 0.6 | 0.5 | 0.21 |

*Wd = (Average Creepage in cm − 0.1 cm)/2

NANOBYK 3841 showed excellent corrosion protection even at very low ZnO dosages of 0.5wt % and 1 wt. %. The protection was as good as with 18.3% of a conventional corrosion inhibitor mixture. The conventional corrosion inhibitors were not used according to the present claims.

The experimental results demonstrate that the nanoparticles have a dramatic influence on the resin and coating structures. The nanoparticles may form a unique structure that gives the positive enhancements to the coating with the high energy influence of the nanoparticles. This is found with pre dispersed nanoparticles that have a wetting additive added to the surface to control the steric hindrance or a treatment of silicone with varying polar charges to be more homogeneous with resins.

Although the embodiments have been described in detail through the above description and the preceding examples, these examples are for the purpose of illustration only and it is understood that variations and modifications can be made by one skilled in the art without departing from the spirit and the scope of the disclosure. It should be understood that the embodiments described above are not only in the alternative, but can be combined.

1. A coating for a substrate for increasing the corrosion resistance of the substrate, the coating comprising a cured coating composition which cured coating composition comprises:
i) 5 to 99 weight % binder (A) and
ii) 0.2 to 4.5 weight % nanoparticles (B),
wherein the nanoparticles (B) comprise at least one of ZnO, CeO₂, Al₂O₃, SiO₂, Al(O)OH, TiO₂, ZrO₂, oxide hydroxides, hydroxides, phosphates, molvbdates, tungstates, vanadates, silicates, chromates, nitrites, sulfates, conductive polymers, or combinations thereof;
the nanoparticles (B) have diameters greater than 5 nm and below 200 nm:
the surface of the nanoparticles (B) is treated with at least one surface modifying group, wherein the surface of the nanoparticles (B) is modified by:
(1) polvdialkylsiloxanes;
(2) polar polvdialkylsiloxanes;
(3) polymeric modifiers;
(4) organosilanes;
(5) wetting and/or dispersing additives; or
(6) mixtures of one or more of the aforementioned substances (1) through (5);
wherein the substrate is metallic; and,
wherein the cured coating composition is adapted to be in direct or indirect contact with the substrate.

2. The coating according to claim 1, wherein the cured coating composition has a modulus of elasticity that is decreased by 10% in comparison to a non particle containing coating material.

3. The coating according to claim 1, wherein the cured coating composition is transparent.

4. (canceled)

5. The coating according to claim 1, wherein the binder (A) comprises a crosslinkable or non-crosslinkable resin.

6. The coating according to claim 1, wherein the nanoparticles (B) comprise at least one of ZnO, CeO₂, Al₂O₃. SiO₂, Al(O)OH, TiO₂, ZrO₂, oxide hydroxides, hydroxides, phosphates, molybdates, tungstates, vanadates, silicates, chromates, nitrites or sulfates.

7. The coating according to claim 1, wherein the diameter of the nanoparticles (B) is below 100 and greater than 10 nm.

8. (canceled)

9. The coating according to claim 1, wherein the surface of the nanoparticles (B) is modified by the surface modifying group attaching to the surface of the nanoparticles via at least one chemical or non chemical bond, a covalent, non covalent, or physical bond.

10. The coating according to claim 1, wherein the coating contains a surface active agent (C) not being a modifier of the particles (B).

11. The coating according to claim 1, wherein the metallic substrate comprises a metal, metal mixture, metal composite or metal alloys that may experience any means of corrosion.

12. The coating according to claim 1, wherein cured coating composition contains has a depth between 15 and 900 μm.

13. The coating according to claim 1, wherein between the cured coating composition and the substrate are embedded one or more further coating layers which contain pigments and/or fillers.

14. The coating according to claim 1, wherein the cured coating composition is directly bound to the metallic substrate or alternatively a cathodic protection coating of 5 to 30 μm in depth is directly embedded between the metallic substrate and the cured coating composition.

15. (canceled)

16. The coating according to claim 5, wherein the resin comprises at least one of the classes of acrylics, aminoplasts, urethanes, carbamates, carbonates, polyesters, epoxies, silicones or polyamides.

17. The coating according to claim 16, wherein the resin comprises functional groups characteristic of more than one said class.

18. The coating according to claim 5, wherein the binder (A) comprises at least one of one component polyurethanes, two component polyurethanes. acrylics, oil modified urethanes, long oil alkyds, polyurethane dispersions, acrylic emulsions, epoxies, or water reducible alkyds.

19. The coating according to claim 9, wherein the modifying group comprises a spacer component which is unable to undergo reactions with the nanoparticle surface and is inert towards the coating.

20. The coating according to claim 11, wherein the metallic substrate comprises at least one of iron, steel, aluminum, dye-cast-aluminum, dye-cast-alloys, or magnesium-aluminum-alloys.

21. The coating according to claim 1, wherein cured coating composition has a depth between 15 and 30 μm.

22. The coating according to claim 1, wherein the diameter of the nanoparticles (B) is below 60 nm and greater than 20 nm.

23. A method of increasing the corrosion resistance of a metallic substrate, the method comprising applying a coating according to claim 1 on the substrate.

24. A method of increasing the corrosion resistance of a metallic substrate, the method comprising applying a coating on the substrate followed by curing the applied coating, wherein the cured coating coating composition comprises:
i) 5 to 99 weight % binder (A) and
ii) 0.2 to 4.5 weight % nanoparticles (B),
wherein:
the nanoparticles (B) comprise at least one of ZnO, CeO₂, Al₂O₃, SiO₂, Al(O)OH, TiO2, ZrO2, oxide hydroxides, hydroxides, phosphates, molybdates, tungstates, vanadates, silicates, chromates, nitrites, sulfates, conductive polymers or combinations thereof;
the nanoparticles (B) have diameters greater than 5 nm and below 200 nm;
the surface of the nanoparticles (B) is treated with at least one surface modifying group, wherein the surface of the nanoparticles (B) is modified by:
(1) polydialkylsiloxanes;
(2) polar polydialkylsiloxanes;
(3) polymeric modifiers;
(4) organosilanes;
(5) wetting and/or dispersing additives; or
(6) mixtures of one or more of the aforementioned substances (1) through (5);
wherein the substrate is metallic; and,
wherein the cured coating composition is adapted to be in direct or indirect contact with the substrate.

25. A metallic substrate, wherein the substrate is provided with an increased corrosion resistance, on which substrate a coating according to claim 1 has been applied.

26. A metallic substrate, wherein the substrate is provided with an increased corrosion resistance, on which substrate a coating has been applied and subsequently cured, wherein the cured coating coating composition comprises:
i) 5 to 99 weight % binder (A) and
ii) 0.2 to 4.5 weight % nanoparticles (B),
wherein:
the nanoparticles (B) comprise at least one of ZnO, CeO₂, AlO₃, SiO₂, Al(O)OH, TiO₂, ZrO₂, oxide hydroxides, hydroxides, phosphates, molybdates, tungstates, vanadates, silicates, chromates, nitrites, sulfates, conductive polymers or combinations thereof;
the nanoparticles (B) have diameters greater than 5 nm and below 200 nm;
the surface of the nanoparticles (B) is treated with at least one surface modifying group, wherein the surface of the nanoparticles (B) is modified by:
(1) polydialkylsiloxanes;
(2) polar polydialkylsiloxanes;
(3) polymeric modifiers;
(4) organosilanes;
(5) wetting and/or dispersing additives; or
(6) mixtures of one or more of the aforementioned substances (1) through (5);
wherein the substrate is metallic; and,
wherein the cured coating composition is adapted to be in direct or indirect contact with the substrate.
